(19) United States
(12) Patent Application Publication
(10) Pub. No.: US 2022/0027924 A1
(43) Pub. Date: Jan. 27, 2022

(54) METHOD AND SYSTEM FOR AUTHENTICATION OF IDENTIFICATION DOCUMENTS FOR DETECTING POTENTIAL VARIATIONS IN REAL-TIME

(71) Applicant: Signzy Technologies Private Limited, Mumbai (IN)

(72) Inventors: Pragati GARG, Mumbai (IN); Shiv Shankar SUBUDHI, Mumbai (IN); Aadalarasan Bhavani SARAVANAN, Mumbai (IN); Christen MILLER, Mumbai (IN); Chitrangada PATRA, Mumbai (IN); Dinesh AVULA, Mumbai (IN); Ankit RATAN, Mumbai (IN); Arpit RATAN, Mumbai (IN); Ankur PANDEY, Mumbai (IN)

(73) Assignee: Signzy Technologies Private Limited, Mumbai (IN)

(21) Appl. No.: 17/126,035

(22) Filed: Dec. 18, 2020

(51) Int. Cl. G06Q 30/00; G06Q 50/26; G06Q 50/00; G06F 16/17; G06N 20/20; G06N 20/10; G06K 9/00

(52) U.S. Cl. CPC G06Q 30/0185; G06Q 50/265; G06Q 50/01; G06K 19/06028; G06N 20/20; G06N 20/10; G06K 9/00442; G06F 16/17

(57) ABSTRACT

The present disclosure provides a method and system for authentication of one or more identification documents for detecting potential variations in real-time. The system receives a user data from one or more users with facilitation of one or more communication devices in real-time. The system obtains the one or more identification documents associated with the one or more users with facilitation of the one or more communication devices in one or more forms. In addition, the system authenticates each of the one or more identification documents associated with the corresponding user of the one or more users. Further, the system detects potential variations in the one or more identification documents based on heat map analysis with facilitation of one or more hardware run-algorithms. Furthermore, the system alerts one or more organizations for potential fraud based on the heat map analysis.

### TECHNICAL FIELD

The present invention relates to user authentication and, in particular, to a method and system for authentication of user identification documents for detecting potential variations in real-time.

### Introduction

In recent times, many of the companies provide facility to users for online document verification for various deeds on various forms. The online document verification system is introduced to facilitate ease to the user. For example, the user wants to open a bank account. The user is facilitated to upload required documents to the online document verification system. This facility given to the user saves time and money. Nowadays, companies are more vulnerable to fraud by the user. For example, the user may provide forged documents to company C1. This may result in serious consequences for the company C1. In another example, the user may buy cellular sim card with forged documents through online document verification. In addition, the user may use the cellular sim card for militant activities. Due to false information provided by the user, it becomes difficult to track or identify real identity of the user.

### SUMMARY

In an aspect, a computer-implemented method is provided. The computer-implemented method for authentication of one or more identification documents for detecting potential variations in real-time. The computer-implemented method includes a first step of receiving a user data from one or more users with the facilitation of one or more communication devices in real-time. In addition, the computer-implemented method includes another step of obtaining the one or more identification documents associated with the one or more users with the facilitation of the one or more communication devices in one or more forms. Further, the computer-implemented method includes yet another step of authenticating each of the one or more identification documents associated with the corresponding user of the one or more users. Furthermore, the computer-implemented method includes yet another step of detecting potential variations in the one or more identification documents based on heat map analysis with the facilitation of one or more hardware run-algorithms. Moreover, the computer-implemented method includes yet another step of alerting one or more organizations for potential fraud based on the heat map analysis. In addition, the user data corresponds to data related to the basic information of the one or more users. The user data is stored on third-party databases. Further, the one or more identification documents are obtained with the facilitation of the one or more communication devices in one or more forms. Furthermore, the one or more identification documents are authenticated based on heat map analysis. The heat map analysis displays visual graphics as hot spots on area of observed alterations or changes on each of the one or more identification documents in real-time. Moreover, the system verifies the user data with the plurality of information given through the one or more identification documents for preventing the fraud. Also, the alert is sent to the one or more organizations in real-time.

In an embodiment of the present disclosure, the user data includes name data, age data, gender, locations data, contact number data, email address data, criminal record, fraud history, financial data, and communication device information. In an embodiment of the present disclosure, the third-party databases include social media database, government official databases, company databases, and public databases.

In an embodiment of the present disclosure, the one or more forms include joint photographic experts group (JPEG), portable document file (PDF), portable network graphics (PNG), and graphics interchange format (GIF).

In an embodiment of the present disclosure, the one or more identification documents correspond to official entity issued to the one or more users from a plurality of authorized organizations. In addition, the plurality of authorized organization includes election authority, transport authority, income-tax authority, army organization and any other government institution.

In an embodiment of the present disclosure, the one or more identification documents include birth certificate, social security card, voter id card, driving license, passport, welfare card, income tax card, aadhaar card, pan card, ration card, and domicile certificate.

In an embodiment of the present disclosure, the one or more organizations include banking organizations, educational organizations, finance organization, security organization, intelligence organization, and human resource organization.

In an embodiment of the present disclosure, the one or more identification documents include a plurality of information related to the one or more users. In addition, the plurality of information includes user name, user age, unique identification code, user image, quick response code, and barcode.

In an embodiment of the present disclosure, the heat map analysis evaluates a plurality of patterns associated with the user image on at least one of the one or more identification documents. In addition, the plurality of patterns includes color scheme, choropleth map, tree map, mosaic plot and density function.

In an embodiment of the present disclosure, the one or more hardware run-algorithms include decision tree machine learning algorithm, random forest machine learning algorithm, naive bayes classifier machine learning algorithm, support vector machine learning algorithm, k-nearest neighbors machine learning algorithm, and linear regression machine learning algorithm.

In another aspect, a computer system is provided. The computer system may include one or more processors and a memory coupled to the one or more processors. The memory may store instructions which, when executed by the one or more processors, may cause the one or more processors to perform a method. The method for authentication of one or more identification documents for detecting potential variations in real-time. The method includes a first step of receiving a user data from one or more users with the facilitation of one or more communication devices in real-time. In addition, the method includes another step of obtaining the one or more identification documents associated with the one or more users with the facilitation of the one or more communication devices in one or more forms. Further, the method includes yet another step of authenticating each of the one or more identification documents associated with the corresponding user of the one or more users. Furthermore, the method includes yet another step of detecting potential variations in the one or more identification documents based on heat map analysis with the facilitation of one or more hardware run-algorithms. Moreover, the method includes yet another step of alerting one or more organizations for potential fraud based on the heat map analysis. In addition, the user data corresponds to data related to the basic information of the one or more users. The user data is stored on third-party databases. Further, the one or more identification documents are obtained with the facilitation of the one or more communication devices in one or more forms. Furthermore, the one or more identification documents are authenticated based on heat map analysis. The heat map analysis displays visual graphics as hot spots on area of observed alterations or changes on each of the one or more identification documents in real-time. Moreover, the heat map analysis evaluates a plurality of patterns associated with the user image on at least one of the one or more identification documents. The plurality of patterns includes color scheme, choropleth map, tree map, mosaic plot and density function. The system verifies the user data with the plurality of information given through the one or more identification documents for preventing the fraud. Also, the alert is sent to the one or more organizations in real-time.

In yet another aspect, a computer-readable storage medium is provided. The computer-readable storage medium encodes computer executable instructions that, when executed by at least one processor, performs a method. The method for authentication of one or more identification documents for detecting potential variations in real-time. The method includes a first step of receiving a user data from one or more users with the facilitation of one or more communication devices in real-time. In addition, the method includes another step of obtaining the one or more identification documents associated with the one or more users with the facilitation of the one or more communication devices in one or more forms. Further, the method includes yet another step of authenticating each of the one or more identification documents associated with the corresponding user of the one or more users. Furthermore, the method includes yet another step of detecting potential variations in the one or more identification documents based on heat map analysis with the facilitation of one or more hardware run-algorithms. Moreover, the method includes yet another step of alerting one or more organizations for potential fraud based on the heat map analysis. In addition, the user data corresponds to data related to the basic information of the one or more users. The user data is stored on third-party databases. Further, the one or more identification documents are obtained with the facilitation of the one or more communication devices in one or more forms. The one or more forms includes joint photographic experts group (JPEG), portable document file (PDF), portable network graphics (PNG), and graphics interchange format (GIF). The one or more identification documents includes a plurality of information related to the one or more users. The plurality of information includes user name, user age, unique identification code, user image, quick response code, and barcode. The one or more identification documents correspond to official entity issued to the one or more users from a plurality of authorized organizations. The plurality of authorized organization includes election authority, transport authority, income-tax authority, army organization and any other government institution. Furthermore, the one or more identification documents are authenticated based on heat map analysis. The heat map analysis displays visual graphics as hot spots on area of observed alterations or changes on each of the one or more identification documents in real-time. Moreover, the heat map analysis evaluates a plurality of patterns associated with the user image on at least one of the one or more identification documents. The plurality of patterns includes color scheme, choropleth map, tree map, mosaic plot and density function. The plurality of patterns includes color scheme, choropleth map, tree map, mosaic plot and density function. Also, the system verifies the user data with the plurality of information given through the one or more identification documents for preventing the fraud. Also, the alert is sent to the one or more organizations in real-time. The one or more organizations includes banking organizations, educational organizations, finance organization, security organization, intelligence organization, and human resource organization.

### BRIEF DESCRIPTION OF THE FIGURES

Having thus described the disclosure in general terms, reference will now be made to the accompanying figures, wherein;

FIG. 1 illustrates an interactive computing environment for authentication of one or more identification documents for detecting potential variations in real-time, in accordance with various embodiments of the present disclosure;

FIG. 2 is a flowchart for authentication of one or more identification documents for detecting potential variations in real-time, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

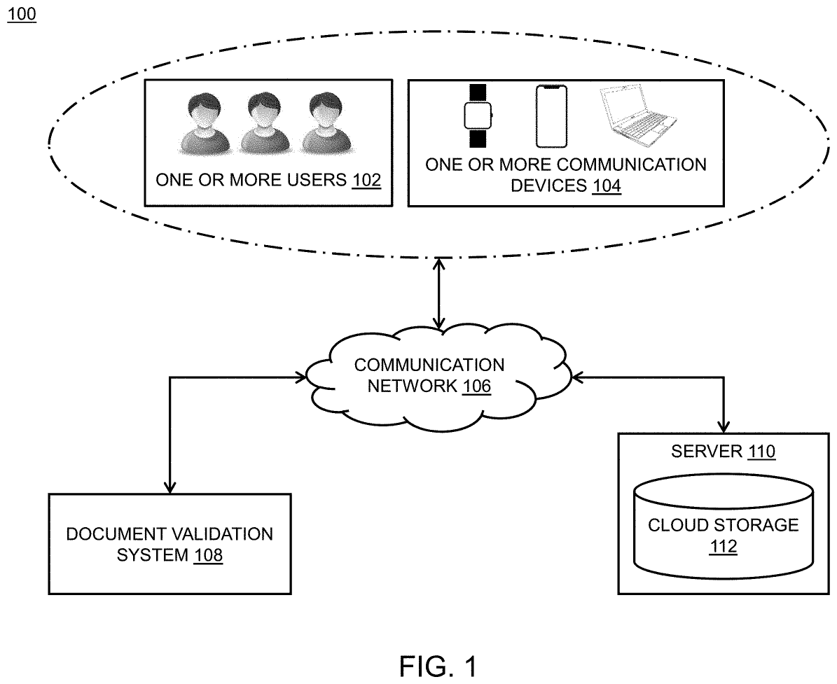

FIG. 1 illustrates an interactive computing environment 100 for authentication of one or more identification documents for detecting potential variations in real-time, in accordance with various embodiments of the present disclosure. The interactive computing environment 100 shows a relationship between various entities involved in the authentication of the user identification documents for detecting potential variations in real-time.

The interactive computing environment 100 includes one or more users 102, one or more communication devices 104, and a communication network 106. In addition, the interactive computing environment 100 includes a document validation system 108, a server 110, and a cloud storage 112. The above-stated elements of the interactive computing environment 100 operate coherently and synchronously. In an embodiment of the present disclosure, the interactive computing environment 100 is configured to authenticate user identification documents for detecting potential variations.

The interactive computing environment 100 includes the one or more users 102. The one or more users 102 may be any person or an individual submitting identification documents to concerned authorities. In addition, the one or more users 102 may be any person or an individual looking for verification of the identification documents. In an example, a user U1 submits social security number to a banking institution for opening a savings account with them. Further, the document validation system 108 authenticates the social security number of the user U1 in real-time. In an embodiment of the present disclosure, the one or more users 102 is associated with the one or more communication devices 104. In another example, the one or more users 102 is an owner of the one or more communication devices 104. In another example, the one or more users 102 may not be the owner of the one or more communication devices 104. In yet another embodiment of the present disclosure, the one or more users 102 may be a person who wants to authenticate various documents from the document validation system 108. In yet another embodiment of the present disclosure, the one or more users 102 may be any person. In yet another embodiment of the present disclosure, the one or more users 102 may interact with the document validation system 108 directly through the one or more communication devices 104. In yet another embodiment of the present disclosure, the one or more users 102 may interact with the document validation system 108 via the one or more communication devices 104 through the communication network 106.

The interactive computing environment 100 includes the one or more communication devices 104. In general, communication device refer to equipment or device capable of transmitting analog or digital signals through communication wire or remote way. In an embodiment of the present disclosure, the one or more communication devices 104 include a computer, laptop, smart television, PDA, electronic tablet, smartphone, wearable devices, tablet, smartwatch, smart display, gesture-controlled devices, and the like. In an example, the one or more communication devices 104 display, read, transmit and gives output to the one or more users 102 in real-time. The one or more users 102 may access the one or more communication devices 104 while moving from one place to another place. In an example, place includes home, park, restaurant, any facility, college, university, office and the like.

In general, communication devices are used for one or more purposes. In an example, the one or more purposes include communication, entertainment, accessing web-based platforms for different tasks and the like. In an embodiment of the present disclosure, the one or more communication devices 104 includes a mobile application. The mobile application is installed in the one or more communication devices 104. In general, mobile application performs various tasks such as handling notifications and connectivity. In addition, mobile application is programmed in different languages for different platforms. Moreover, use of mobile application in online mode and offline mode depends on the type of application used. In an example, mobile applications are used for entertainment, productivity, marketing and accessing various e-commerce and web-based platforms.

In addition, the one or more communication devices 104 are associated with a camera, a global positioning system, keypad, touchscreen, and the like. In an embodiment of the present disclosure, the one or more users 102 input manual data using keypad. In another embodiment of the present disclosure, the one or more users 102 input manual data using touchscreen. In an embodiment of the present disclosure, the one or more communication devices 104 are connected to the document validation system 108 with facilitation of the communication network 106.

Further, the communication network 106 denotes channels of communication (networks by which information flows). In an embodiment of the present disclosure, the communication network 106 includes LAN, MAN, WAN, and the like. The local area network, or LAN, cable or fiber, is used to connect computer equipment and other terminals distributed in the local area, such as in the university campus. The Metropolitan Area Network or MAN is a high-speed network that is used to connect a small geographical area such as a LAN across the city. Wide area networks, or any communication connections, including WAN, microwave radio link and satellite, are used to connect computers and other terminals to a larger geographic distance. In another embodiment of the present disclosure, the communication network 106 may be any type of network that provides internet connectivity to the document validation system 108. In yet another embodiment of the present disclosure, the communication network 106 may be any type of network that provides internet connectivity to the one or more communication devices 104. In an embodiment of the present disclosure, the communication network 106 is a wireless mobile network. In another embodiment of the present disclosure, the communication network 106 is a wired network with finite bandwidth. In yet another embodiment of the present disclosure, the communication network 106 is a combination of the wireless and the wired network for optimum throughput of data transmission. In yet another embodiment of the present disclosure, the communication network 106 is an optical fiber high bandwidth network that enables high data rate with negligible connection drops. In yet another embodiment of the present disclosure, the communication network 106 provides medium for the one or more communication devices 104 to connect to the document validation system 108. In this scenario, the communication network 106 may be a global network of computing devices such as the Internet.

In an embodiment of the present disclosure, the one or more communication devices 104 are connected to internet in real-time. Further, the one or more communication devices 104 is associated with a specific type of operating system. The specific type of operating system includes an android operating system, a windows operating system, a mac operating system and the like. Moreover, the one or more communication devices 104 are connected to the internet through the communication network 106. In an embodiment of the present disclosure, the one or more communication devices 104 are connected to the internet through a data connection provided by a telecom service provider. In addition, the telecom service provider is associated with a subscriber identification module card located inside the one or more communication devices 104. Further, the one or more communication devices 104 may be connected to the internet through a WiFi connection.

In an embodiment of the present disclosure, the one or more communication devices 104 are associated with the document validation system 108. In addition, the one or more communication devices 104 are connected with the document validation system 108 through the communication network 106. In an embodiment of the present disclosure, the communication network 106 enables the one or more communication devices 104 to gain access to the internet. Moreover, the one or more communication devices 104 provides a medium for transferring information between the one or more communication devices 104 and the document validation system 108. In an example, the medium for communication may be infrared, microwave, radio frequency (RF) and the like.

The interactive computing environment 100 includes the document validation system 108. The document validation system 108 performs one or more steps to authenticate the user identification documents to detect the potential variations. In addition, the document validation system 108 performs the one or more steps to facilitate the one or more users 102 to determine authenticity of the user identification documents in real-time. In an embodiment of the present disclosure, the document validation system 108 may ask the one or more users 102 to upload the one or more identification documents associated with the identification of the one or more users 102. The one or more identification documents include a plurality of information related to the one or more users 102. In addition, the plurality of information includes user name, user age, unique identification code, user image, quick response code, barcode, and the like.

In an embodiment of the present disclosure, the document validation system 108 authenticates the one or more identification documents based on heat map analysis. In general, heat map analysis is a process of reviewing and analyzing heat map data to gather insights about user interaction on page or document. The heat map analysis runs on one or more hardware run-algorithms in real-time. The one or more hardware run-algorithms include decision tree machine learning algorithm, random forest machine learning algorithm, naive bayes classifier machine learning algorithm, support vector machine learning algorithm, k-nearest neighbors machine learning algorithm, linear regression machine learning algorithm, and the like.

The interactive computing environment 100 includes the server 110. In an embodiment of the present disclosure, the document validation system 108 is associated with the server 110. In another embodiment of the present disclosure, the one or more communication devices 104 are associated with the server 110. In an embodiment of the present disclosure, the document validation system 108 is installed at the server 110. In another embodiment of the present disclosure, the document validation system 108 is installed at a plurality of servers. In general, server refers to a computer that provides data to other computers. In addition, server may serve data to systems on a local area network (LAN) or a wide area network (WAN) over the Internet. Further, many types of servers exist, including web servers, mail servers, file servers, and the like. Furthermore, each type of server runs software specific to the purpose of the server. In an example, a web server may run Apache HTTP Server or Microsoft IIS, which both provide access to websites over the Internet. In another example, mail server may run a program like Exim or I Mail, which provides SMTP services for sending and receiving the email. In yet another example, file server might use Samba or the operating system's built-in file-sharing services to share files over a network. While server software is specific to the type of server, the hardware is not as important. In fact, a regular desktop computer can be turned into a server by adding the appropriate software. In an example, a computer connected to a home network can be designated as a file server, print server, or both. In another example, the plurality of servers may include a database server, file server, application server and the like. The plurality of servers communicates with each other using the communication network 106.

The interactive computing environment 100 includes the cloud storage 112. In general, a cloud platform refers to a data structure that stores organized information. Most cloud platforms contain multiple tables, which may each include several different fields. In an example, the cloud platform 112 may include records related to user demographic data, user social data, user location, legal document information of the one or more users 102, and the like. In an embodiment of the present disclosure, one or more user profiles are stored on the cloud platform 112. In addition, the one or more user profiles available on the one or more web-based platforms may include data and information of the one or more users 102 available on the one or more social networking platforms. In an example, the social networking platform includes Facebook, Instagram, LinkedIn, Twitter, and the like. In another embodiment of the present disclosure, the data available on the one or more web-based platforms is the data filled by the one or more users 102 in past time. In an example, the one or more users 102 updates the data on the one or more web-based platforms on a regular basis.

In an embodiment of the present disclosure, the document validation system 108 receives a user data from the one or more users 102 with facilitation of the one or more communication devices 104 in real-time. The user data corresponds to data related to the basic information of the one or more users 102. In addition, the user data includes name data, age data, gender, locations data, contact number data, email address data, criminal record, fraud history, financial data, communication device information, and the like. In another embodiment of the present disclosure, the user data is received from third-party databases. In yet another embodiment of the present disclosure, the user data is stored in the third-party databases. The third-party databases include social media database, government official databases, company databases, public databases, and the like.

In an embodiment of the present disclosure, the document validation system 108 obtains the one or more identification documents associated with the one or more users 102. In addition, the document validation system 108 obtains the one or more identification documents with facilitation of the one or more communication devices 104. Further, the document validation system 108 obtains the one or more identification documents in one or more forms. The one or more forms include joint photographic experts group (JPEG), portable document file (PDF), portable network graphics (PNG), graphics interchange format (GIF), and the like. Further, the one or more identification documents include birth certificate, social security card, voter id card, driving license, passport, welfare card, income tax card, aadhaar card, pan card, ration card, domicile certificate, and the like. In an example, user U2 uploads driving license on the document validation system 108 in PDF format for application of transport license of heavy vehicles. In an example, user U3 is asked to upload social security card for document verification on application of loan from bank B1. In an embodiment of the present disclosure, the one or more identification documents correspond to official entity issued to the one or more users 102 from a plurality of authorized organizations. The plurality of authorized organizations include but may not be limited to election authority, transport authority, income-tax authority, army organization, and any other government institution.

In an embodiment of the present disclosure, the document validation system 108 authenticates each of the one or more identification documents associated with the corresponding user of the one or more users 102. The one or more identification documents are authenticated based on the heat map analysis. The heat map analysis displays visual graphics as hot spots on area of observed alterations or changes on each of the one or more identification documents in real-time. Also, the heat map analysis evaluates a plurality of patterns associated with the user image on at least one of the one or more identification documents. The plurality of patterns includes color scheme, choropleth map, tree map, mosaic plot, density function, and the like.

The document validation system 108 detects the potential variations in the one or more identification documents based on the heat map analysis. In an embodiment of the present disclosure, the document validation system 108 detects the potential variations in the one or more identification documents with facilitation of the one or more hardware run-algorithms in real-time. In addition, the document validation system 108 verifies the user data with the plurality of information given through the one or more identification documents for preventing the fraud. In an example, user U3 uploads birth certificate B1 for the application of driving license. The document validation system 108 determines that age of the user U3 mentioned on the birth certificate B1 is altered.

In an embodiment of the present disclosure, the document validation system 108 alerts to one or more organizations for potential fraud based on the heat map analysis. In addition, the alert is sent to the one or more organizations in real-time. The one or more organizations include banking organizations, educational organizations, finance organization, security organization, intelligence organization, human resource organization, and the like. In an example, user U4 applied for credit card with company C1. The company C1 asked the user U4 to upload income tax return R1 for income verification. The document validation system 108 determines that income figures on the filed income tax return R1 is altered. Further, the document validation system 108 informs the company C1 for potential fraud by the user U4.

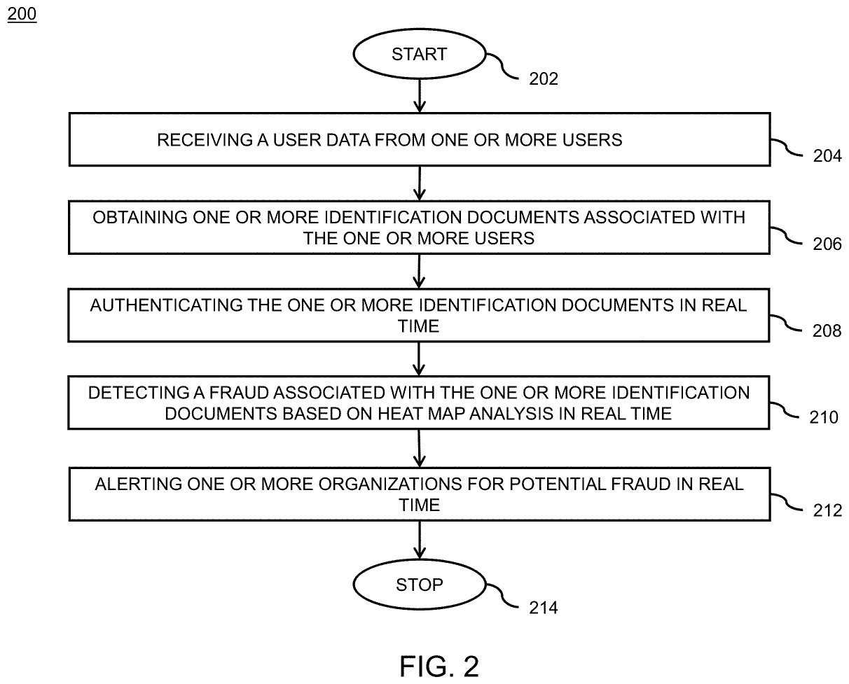

FIG. 2 is a flowchart 200 for authentication of one or more identification documents for detecting potential variations in real-time, in accordance with various embodiments of the present disclosure. The flowchart 200 initiates at step 202. Following step 202, at step 204 the document validation system 108 receives the user data from the one or more users 102. At step 206, the document validation system 108 obtains the one or more identification documents associated with the one or more users 102. At step 208, the document validation system 108 authenticates the one or more identification documents in real-time. At step 210, the document validation system 108 detects the potential variations in the one or more identification documents based on the heat map analysis in real-time. At step 212, the document validation system 108 alerts the one or more organizations for potential fraud in real-time. The flow chart 200 terminates at step 214.

It may be noted that the flowchart 200 is explained to have above stated process steps; however, those skilled in the art would appreciate that the flowchart 200 may have more/less number of process steps which may enable all the above-stated embodiments of the present disclosure.

The document validation system 108 may be implemented using a single computing device, or a network of computing devices, including cloud-based computer implementations. The computing devices are preferably server class computers including one or more high-performance computer processors and random-access memory and running an operating system such as LINUX or variants thereof. The operations of the document validation system 108 as described herein can be controlled through either hardware or through computer programs installed in a non-transitory computer-readable storage devices such as solid-state drives or magnetic storage devices and executed by the processors to perform the functions described herein. The cloud storage 112 is implemented using non-transitory computer-readable storage devices, and suitable database management systems for data access and retrieval. The document validation system 108 includes other hardware elements necessary for the operations described herein, including network interfaces and protocols, input devices for data entry, and output devices for display, printing, or other presentations of data. Additionally, the operations listed here are necessarily performed at such a frequency and over such a large set of data that they must be performed by a computer in order to be performed in a commercially useful amount of time, and thus cannot be performed in any useful embodiment by mental steps in the human mind.

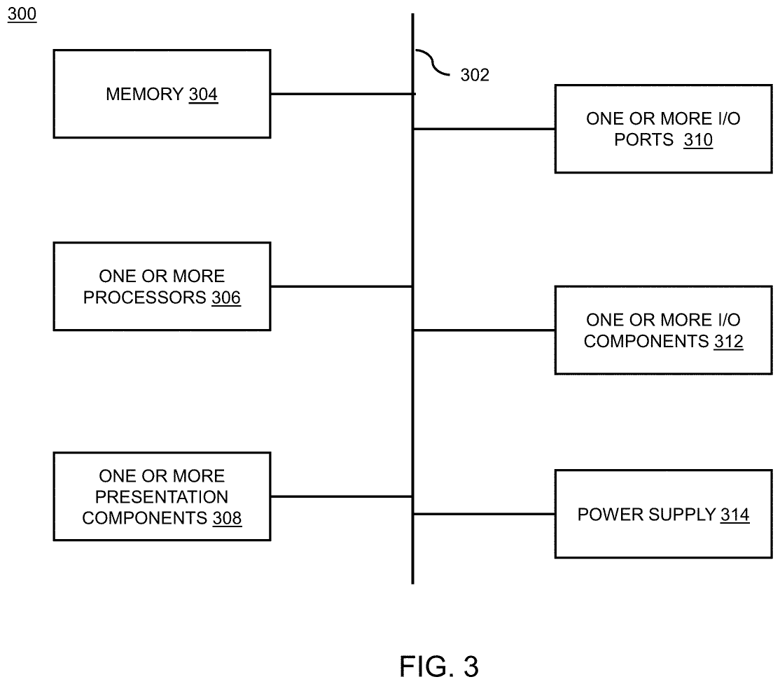

FIG. 3 illustrates a block diagram of the device 300, in accordance with various embodiments of the present disclosure. The device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary device 300 that can be used in connection with one or more embodiments of the present invention. The distinction is not made between such categories as “workstation,” “server,” “laptop,” “hand-held device,” etc., as all are contemplated within the scope of FIG. 3 and reference to “computing device.”

The device 300 typically includes a variety of computer-readable media. The computer-readable media can be any available media that can be accessed by the device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, non-transitory computer-readable storage medium that stores program code and/or data for short periods of time such as register memory, processor cache and random access memory (RAM), or any other medium which can be used to store the desired information and which can be accessed by the device 300. The computer storage media includes, but is not limited to, non-transitory computer readable storage medium that stores program code and/or data for longer periods of time, such as secondary or persistent long term storage, like read-only memory (ROM), EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The device 300 includes the one or more processors 306 that read data from various entities such as memory 304 or I/O components 312. The one or more presentation components 308 present data indications to the user 102 or another device. Exemplary presentation components include a display device, speaker, printing component, vibrating component, etc. The one or more I/O ports 310 allow the device 300 to be logically coupled to other devices including the one or more I/O components 312, some of which may be built-in. Illustrative components include a microphone, joystick, gamepad, satellite dish, scanner, printer, wireless device, etc.

The foregoing descriptions of pre-defined embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed:

1. A computer-implemented method for authentication of one or more identification documents for detecting potential variations in real-time, the computer-implemented method comprising:
receiving, at a document validation system with a processor, a user data from one or more users with facilitation of one or more communication devices in real-time, wherein the user data is stored in third-party databases;
obtaining, at the document validation system with the processor, one or more identification documents associated with the one or more users in real-time, wherein the one or more identification documents are obtained with facilitation of the one or more communication devices, wherein the one or more identification documents are obtained in one or more forms;
authenticating, at the document validation system with the processor, each of the one or more identification documents associated with corresponding user of the one or more users, wherein the one or more identification documents are authenticated based on heat map analysis, wherein the heat map analysis displays visual graphics as hot spots on area of observed alterations or changes on each of the one or more identification documents in real-time;
detecting, at the document validation system with the processor, potential variations in the one or more identification documents based on the heat map analysis with facilitation of one or more hardware run-algorithms; and
alerting, at the document validation system with the processor, one or more organizations for potential fraud based on the heat map analysis, wherein the alert is sent to the one or more organizations in real-time.

2. The computer-implemented method as recited in claim 1, wherein the user data comprises name data, age data, gender, location data, contact number data, email address data, criminal record, fraud history, financial data, and communication device information.

3. The computer-implemented method as recited in claim 1, wherein the third-party databases comprises social media databases, government official databases, company databases, and public databases.

4. The computer-implemented method as recited in claim 1, wherein the one or more forms comprises joint photographic experts group (JPEG), portable document file (PDF), portable network graphics (PNG), and graphics interchange format (GIF).

5. The computer-implemented method as recited in claim 1, wherein the one or more identification documents correspond to official identity documents issued to the one or more users from a plurality of authorized organizations, wherein the plurality of authorized organizations comprises election authority, transport authority, income-tax authority, army organization and any other government institution.

6. The computer-implemented method as recited in claim 1, wherein the one or more identification documents comprises birth certificate, social security card, voter id card, driving license, passport, welfare card, income tax card, and domicile certificate.

7. The computer-implemented method as recited in claim 1, wherein the one or more organizations comprises banking organizations, educational organizations, finance organization, security organization, intelligence organization, and human resource organization.

8. The computer-implemented method as recited in claim 1, wherein the one or more identification documents comprises a plurality of information related to the one or more users, wherein the plurality of information comprises user name, user age, unique identification code, user image, quick response code, and barcode.

9. The computer-implemented method as recited in claim 1, wherein the heat map analysis evaluates a plurality of patterns associated with a user image on at least one of the one or more identification documents, wherein the plurality of patterns comprises color scheme, choropleth map, tree map, mosaic plot and density function.

10. The computer-implemented method as recited in claim 1, wherein the one or more hardware run-algorithms comprises decision tree machine learning algorithm, random forest machine learning algorithm, naive bayes classifier machine learning algorithm, support vector machine learning algorithm, k-nearest neighbors machine learning algorithm, and linear regression machine learning algorithm.

11. A computer system comprising:
one or more processors; and
a memory coupled to the one or more processors, the memory for storing instructions which, when executed by the one or more processors, cause the one or more processors to perform a method for authenticating one or more identification documents for detecting potential variations in real-time, the computer-implemented method comprising:
receiving, at a document validation system, a user data from one or more users with facilitation of one or more communication devices in real-time, wherein the user data is stored in third-party databases;
obtaining, at the document validation system, one or more identification documents associated with the one or more users in real-time, wherein the one or more identification documents are obtained with the facilitation of the one or more communication devices, wherein the one or more identification documents are obtained in one or more forms;
authenticating, at the document validation system, each of the one or more identification documents associated with the corresponding user of the one or more users, wherein the one or more identification documents are authenticated based on heat map analysis, wherein the heat map analysis displays visual graphics as hot spots on area of observed alterations or changes on each of the one or more identification documents in real-time;
detecting, at the document validation system, potential variations in the one or more identification documents based on the heat map analysis with facilitation of one or more hardware run-algorithms, wherein the heat map analysis evaluates a plurality of patterns associated with a user image on at least one of the one or more identification documents, wherein the plurality of patterns comprises color scheme, choropleth map, tree map, mosaic plot and density function; and
alerting, at the document validation system, one or more organizations for potential fraud based on the heat map analysis, wherein the alert is sent to the one or more organizations in real-time.

12. The computer system as recited in claim 11, wherein the user data comprises name data, age data, gender, locations data, contact number data, email address data, criminal record, fraud history, financial data, and communication device information.

13. The computer system as recited in claim 11, wherein the third-party databases comprises social media database, government official databases, company databases, and public databases.

14. The computer system as recited in claim 11, wherein the one or more forms comprises joint photographic experts group (JPEG), portable document file (PDF), portable network graphics (PNG), and graphics interchange format (GIF).

15. The computer system as recited in claim 11, wherein the one or more identification documents correspond to official entity issued to the one or more users from a plurality of authorized organizations, wherein the plurality of authorized organization comprises election authority, transport authority, income-tax authority, army organization and any other government institution.

16. The computer system as recited in claim 11, wherein the one or more identification documents comprises birth certificate, social security card, voter id card, driving license, passport, welfare card, income tax card, ration card and domicile certificate.

17. The computer system as recited in claim 11, wherein the one or more organizations comprises banking organizations, educational organizations, finance organization, security organization, intelligence organization, and human resource organization.

18. The computer system as recited in claim 11, wherein the one or more identification documents comprises a plurality of information related to the one or more users, wherein the plurality of information comprises user name, user age, unique identification code, user image, quick response code, and barcode.

19. The computer system as recited in claim 11, wherein the one or more hardware run-algorithms comprises decision tree machine learning algorithm, random forest machine learning algorithm, naive bayes classifier machine learning algorithm, support vector machine learning algorithm, k-nearest neighbors machine learning algorithm, and linear regression machine learning algorithm.

20. A non-transitory computer-readable storage medium encoding computer executable instructions that, when executed by at least one processor, perform a method for authentication of one or more identification documents for detecting potential variations in real-time, the computer-implemented method comprising:
receiving, at a computing device, a user data from one or more users with facilitation of one or more communication devices in real-time, wherein the user data is stored in third-party databases;
obtaining, at the computing device, one or more identification documents associated with the one or more users in real-time, wherein the one or more identification documents are obtained with facilitation of the one or more communication devices, wherein the one or more identification documents are obtained in one or more forms;
authenticating, at the computing device, each of the one or more identification documents associated with the corresponding user of the one or more users, wherein the one or more identification documents are authenticated based on heat map analysis, wherein the heat map analysis displays visual graphics as hot spots on area of observed alterations or changes on each of the one or more identification documents in real-time;
detecting, at the computing device, potential variations in the one or more identification documents based on the heat map analysis with the facilitation of one or more hardware run-algorithms, wherein the heat map analysis evaluates a plurality of patterns associated with a user image on at least one of the one or more identification documents, wherein the plurality of patterns comprises color scheme, choropleth map, tree map, mosaic plot and density function; and
alerting, at the computing device, one or more organizations for potential fraud based on the heat map analysis, wherein the alert is sent to the one or more organizations in real-time.
